(19) United States
(12) Patent Application Publication
(10) Pub. No.: US 2025/0155667 A1
(43) Pub. Date: May 15, 2025

(54) LENS BARREL, AND OPTICAL DEVICE

(71) Applicant: CANON KABUSHIKI KAISHA, Tokyo (JP)

(72) Inventor: KUNIHIKO SASAKI, Tochigi (JP)

(21) Appl. No.: 18/925,480

(22) Filed: Oct. 24, 2024

(30) Foreign Application Priority Data
Nov. 10, 2023 (JP) 2023-191914

(51) Int. Cl. G02B 7/04

(52) U.S. Cl. CPC G02B 7/04

(57) ABSTRACT

A lens barrel 100 can quickly avoid collisions between moving lens frames having overlapping regions within their movement ranges at the time of a reset drive using a simple configuration, and has moving lens frames 101, and 102 that have overlapping regions OL in their movement ranges M1, and M2; drive units 103, and 104 that move the moving lens frames 101, and 102 in an optical axis direction O; a detection unit 130 configured to detect reference positions P1, and P3 of the moving lens frames 101, and 102; and a control unit J configured to perform a reset drive that moves the moving lens frames 101, and 102 to reference positions P1, and P3, wherein the control unit C changes reset drive conditions for the moving lens frames 101, and 102 based on outputs from the detection unit 130.

### BACKGROUND

### Technical Field

The present disclosure relates to a lens barrel and an optical device.

### Description of the Related Art

Image capturing devices such as digital cameras, video cameras, and the like (optical devices) perform magnification (zooming) and focal point adjustment (focusing) by moving a moving lens frame that holds a lens in an optical axis direction using a drive force from a drive source. Stepping motors, voice coil motors (VCMs) that are configured by magnets and coils, and the like are known as drive mechanisms (drive sources) for moving a moving lens frame.

Generally, in cases in which a moving lens frame is driven by a drive force from a drive source such as a stepping motor or the like, a reference position for the moving lens frame on the optical axis that becomes the drive origin is set, and the moving lens frame is moved from this position. At this time, the reference position for the moving lens frame on the optical axis is determined, and as the position determining drive control method that will be used thereafter to drive the moving lens frame, a so-called open loop control method is commonly used.

The open loop control method does not need a detecting apparatus in order to perform moment by moment detection of the positions on the optical axis of the moving lens frame. In addition, the open loop control method has the benefit of being more simple and smaller in comparison to control systems in which the configuration of the control system is a closed loop control method.

However, in an open loop control method that uses a drive source such as a stepping motor or the like, in a case in which positioning control for a moving lens frame is performed, it is necessary to make the drive start position for the stepping motor and the drive start position for this moving lens frame the same. Therefore, it becomes necessary to return a moving lens group to a specific reference position on the optical axis before starting the positioning drive control. Therefore, a drive for detecting whether or not the moving lens frame has been positioned in the reference position (reset position) also becomes necessary. A drive for determining such a reset position is referred to as a reset drive (or a reset control).

In addition, in the case of closed loop control, control is also frequently performed using a combination (for example: a GMR element) of a first detection element that detects the reference position and a second detection element that outputs an incremental pulse signal, or control is performed using a single detection element that can detect an absolute position.

Conventionally, a lens control device is known that detects both the reference position for a zoom-use moving lens frame and the reference position for a focusing-use moving lens frame using a single reference position detection unit (a shared photo interrupter), and performs drive control on both moving lens frames. This lens control device is shown in Japanese Patent No. 3384133.

In recent years, optical systems have become more complex, and an optical type that has overlapping regions (overlap) in the movement regions for a plurality of moving lens frames when zooming and when focusing has been proposed.

In an optical type that has overlap, it is necessary to avoid collisions between moving lens frames at the time of a reset and at the time of normal driving.

Japanese Unexamined Patent Application, First Publication No. 2010-210868 discloses an example in which collisions between moving lens frames are avoided by performing the reset drives for a plurality of moving lens frames in a pre-determined order.

Japanese Unexamined Patent Application, First Publication No. 2013-3352 discloses an example that uses a grey code pattern and brush as the means for detecting an absolute value, and uses a GMR as a relative detection unit. It thereby becomes possible to perform detailed detections, making it possible to avoid collisions between moving lens frames at the time of a reset drive even in optical systems having overlap.

### SUMMARY

A lens barrel according to one aspect of the embodiments of the present application has a first moving lens frame and a second moving lens frame, wherein there are overlapping regions in a movement range of the first moving lens frame and a movement range of the second moving lens frame; a drive unit configured to move the first moving lens frame in an optical axis direction and to move the second moving lens frame in the optical axis direction; a detection unit configured to detect a reference position of the first moving lens frame and a reference position of the second moving lens frame; and a control unit configured to perform a reset drive in which the first moving lens frame is moved to the reference position of the first moving lens frame and the second moving lens frame is moved to the reference position of the second moving lens frame; wherein the control unit changes reset drive conditions for the first moving lens frame or the second moving lens frame based on outputs from the detection unit.

Further features of the present disclosure will become apparent from the following description of exemplary embodiments with reference to the attached drawings.

### BRIEF DESCRIPTION OF THE DRAWINGS

FIG. 1 is a disassembled oblique view of a lens barrel according to a First Embodiment.

FIG. 2 is a cross-section view of a lens barrel (when the subject distance at a wide angle end is infinite)

FIG. 3 is a cross-section view of a lens barrel (when the subject distance at a telephoto end is infinite).

FIG. 4 is a diagram showing a relationship between loci of moving lens frames and outputs of photo interrupters in the First Embodiment.

FIG. 5 is a diagram showing a relationship between loci of moving lens frames and outputs of photo interrupters in a Second Embodiment.

FIG. 6 is a diagram showing a relationship between loci of moving lens frames and an output of photo interrupters in a Third Embodiment.

### DESCRIPTION OF THE EMBODIMENTS

Below, embodiments of the present disclosure will be explained with reference to the figures. However, the present disclosure is not limited to the embodiments that are described below. Note that for each figure, the same reference numbers are attached to the same components or elements, and explanations thereof are omitted.

### First Embodiment: Lens Barrel and Optical Device

A lens barrel 100 configures one portion of a camera (an optical device) such as a lens interchangeable type camera, a compact digital camera, or the like. The lens barrel 100 is used by being mounted (in a fixed or detachable manner) to a camera body K that is not shown.

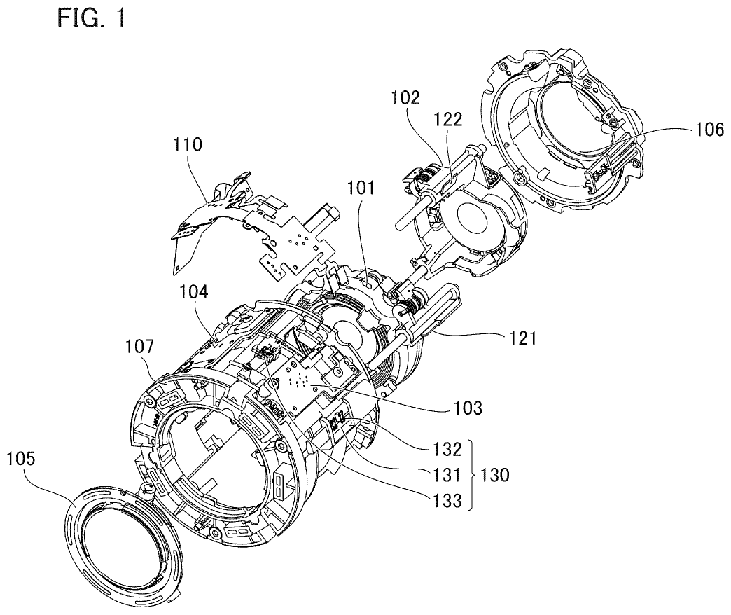

FIG. 1 is a disassembled oblique view of a lens barrel according to the First Embodiment.

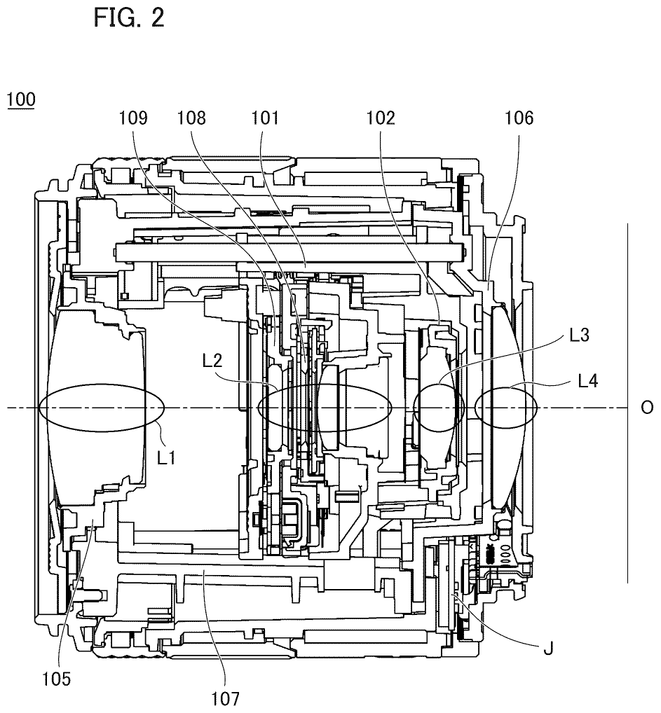

FIG. 2 is a cross-section view of a lens barrel (when the subject distance at a wide-angle end is infinite)

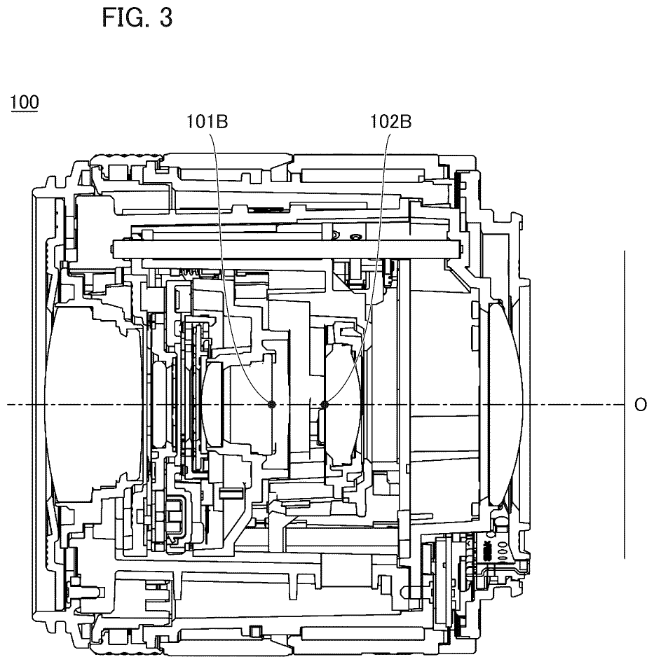

FIG. 3 is a cross-section view of a lens barrel (when the subject distance at a telephoto end is infinite).

The lens barrel 100 is provided with a first group lens L1 to a fourth group lens L4. At least two of the lens groups from among the first group lens L1 to the fourth group lens L4 are held by moving lens frames. That is, a second group unit 101 that comprises a second group lens L2 and a third group unit 102 that comprises a third group lens L3 are moving lens frames that are driven (moved) when zooming is performed or when focusing is performed. In contrast, a first group unit 105 that comprises the first group lens L1, and a fourth group unit 106 that comprises the fourth group lens L4 are fixed units.

The second group unit (the first moving lens frame) 101 is driven along an optical axis O by a first stepping motor 103. In addition, the third group unit (the second moving lens frame) 102 is driven along the optical axis O by a second stepping motor 104.

The second group unit 101 is driven at the time of zooming (a zooming lens frame).

The third group unit 102 is driven at both the time of zooming and the time of focusing (a zooming lens frame and a focusing frame).

The second group unit 101 is provided with an aperture unit 108, a vibration insulation unit 109, and a zoom lens. The mass of the second group unit 101 is larger than the mass of the third group unit 102.

The second group unit 101 has a reference position P in its movement range (optical axis O) and the third group unit 102 also has a reference position P in the movement range (optical axis O). The reference position P is a position that becomes a reference (starting point) when zooming is performed or when focusing is performed. For example, the second group unit 101 has two reference positions, a reference position (a first reference position) P1, and a reference position (a second reference position) P2. The third group unit 102 has one reference position, a reference position (a third reference position) P3.

The lens barrel 100 is provided with a plurality of photo interrupters 130 that detect the reference positions P (P1, P2, and P3). For example, the lens barrel 100 is provided with two photo interrupters (first detection units), a photo interrupter 131, and a photo interrupter 132 in order to detect the two reference positions of the second group unit 101, the reference position P1, and the reference position P2. In addition, the lens barrel 100 is provided with one photo interrupter 133 (a second detection unit) in order to detect the one reference position P3 of the third group unit 102.

The lens barrel 100 is provided with a base cylinder 107 that holds the first group unit 105 and the fourth group unit 106.

The first stepping motor 103 and the third group unit 102 are fixed to the lens barrel 100. The base cylinder 107 holds the ends of two sets of pairs of guide bars (four-legs) that guide the second group unit 101 and the third group unit 102. The other ends of the four legs of the guide bars are held by the fourth group unit 106. In addition, the base unit 107 holds a control substrate (control unit) J.

Furthermore, there is also an exterior unit, and a mounting member, which makes it possible to communicate with and to attach and detach a camera body K (neither of which are shown), that are fixed to the base cylinder 107.

The photo interrupters 130 are all mounted on a flexible printed wiring board 110 and are fixed to the base cylinder 107. The flexible printed wiring board 110 connects to the control substrate J, and fulfills the role of transmitting a control signal and drive power to the first stepping motor 103 and the like.

A rotational force is converted into a straight moving force by the combination of a lead screw and a rack, and the second group unit 101 and the third group unit 102 are driven (moved) along the optical axis O. The second group unit 101 has a light-blocking unit 121, and the third group unit 102 has a light-blocking unit 122. The light blocking units 121 and 122 make the detection light of the photo interrupters 130 translucent or block the light when the second unit 101 and the third group unit 102 are moving (advancing or retreating) along the optical axis O.

The photo interrupters 130 detect the reference positions P (P1, P2, P3, and the like) by switching between being translucent and light-blocking. Furthermore, the photo interrupters 130 also detect the timings at which to switch between being translucent and light-blocking.

In addition, the photo interrupters 130 do not only detect switches between being translucent and light-blocking, they also detect zones (regions) in the movement ranges by distinguishing between translucent and light-blocking states. Zones are regions in which movement regions M1, and M2 have been segmented with the reference positions P as borders.

The detection of zones by the photo interrupters 130 is performed based on output voltage from the photo interrupters 130. Note that below, a translucent state in which the output voltage is low is referred to as low, and a light-blocking state in which the output voltage is high is referred to as high.

In the second group unit 101, the reference positions P1 and P2 are detected by the photo interrupter 131 and the photo interrupter 132. The photo interrupter 131 and the photo interrupter 132 combine their respective translucent and light-blocking states, and can detect at most four zones and three switch timings.

For example, three zone detections (zones A to C to be described below) and two switch timings (the reference positions P1, and P2) are used in the control.

In the third group unit 102, the reference position P3 is detected by the photo interrupter 133. The photo interrupter 133 is able to detect two zones and one switch timing.

For example, in the present embodiment, two zone detections (zones D, and E to be described below), and one switch timing (the reference position P3) are used in the control.

### [Reset Drive]

Next, the reset drive for after the lens barrel 100 has been mounted onto the camera body K will be described. The reset drive is performed based on a command from the control substrate J.

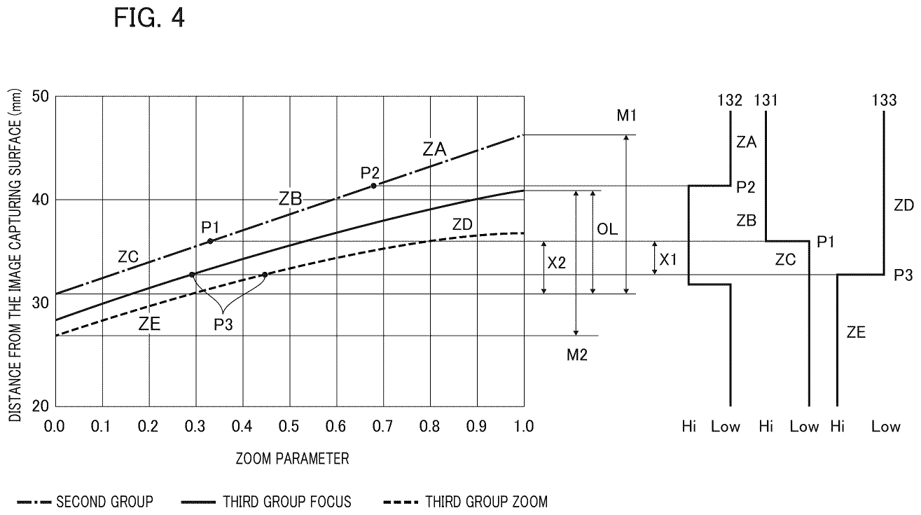

FIG. 4 is a diagram showing the relationship between the loci for the moving lens frames (the second group unit 101 and the third group unit 102) and the outputs of the photo interrupters 130 (photo interrupters 131, 132, and 133) in the First Embodiment. The positions and the like of the second group unit 101 and the third group unit 102 can be made a surface 101B on the image capturing side of the second group unit 101 in relation to the third group unit 102, and a surface 102B on an object side of the third group unit 102 in relation to the second group unit 101 (refer to FIG. 3).

The left diagram in FIG. 4 shows the loci of the zooming and focusing for the second group unit 101 and the third group unit 102. The vertical axis is the distance from the image capturing surface, and the horizontal axis is a zoom parameter. The zoom parameter corresponds to the zoom position. The zoom position indicates a position that has been standardized as the linear movement of the second group unit 101 from wide to telephoto. The zoom parameter is made 0 for the wide-angle end and 1 for the telephoto end.

The right diagram of FIG. 4 shows the switching positions for the outputs of the photo interrupters 131, 132, and 133. The switching positions for outputs of the photo interrupters 131, 132, and 133 correspond to the reference positions P1, P2, and P3.

The region (zone) in which the second group unit 101 exists and the region (zone) in which the third group unit 102 exists are defined in the following manner. If the second group unit 101 exists in a zone A (abbreviation: ZA), the zone A is a region in which the output for the photo interrupter 132 is low and the output for the photo interrupter 131 is high.

If the second group unit 101 exists in a zone B (abbreviation: ZB) the zone B is a region in which the output for the photo interrupter 132 is high, and the output for the photo interrupter 131 is high.

If the second group unit 101 exists in a zone C (abbreviation ZC), then the zone Cis a region in which the output for the photo interrupter 132 is high or low, and the output for the photo interrupter 131 is low. The output for photo interrupter 132 switches between high and low in zone C, and therefore, does not contribute to the detections for the zone C.

If the third group unit 102 exists in a zone D (abbreviation: ZD) then the zone D is a region in which the output for the photo interrupter 133 is low.

If the third group unit 102 exists in a zone E (abbreviation: ZE), then the zone E is a region in which the output for the photo interrupter 133 is high.

The switching position for the zone A and the zone B is the reference position P2, and is detected by the photo interrupter 132.

The switching position for the zone B and the zone C is the reference position P1, and is detected by the photo interrupter 131.

The switching position for the zone D and the zone E is the reference position P3, and is detected by the photo interrupter 133.

The switching positions for the photo interrupters 131, and 132 (the reference positions P1, and P2) are located so as to segment a movement region M1 of the second group unit 101 into three regions (for example, approximately three equal parts).

The switching position for the photo interrupter 133 (the reference position P3) is located so as to segment a movement region M2 of the third group unit 102 into two regions (for example, approximately two equal parts).

There is a region in which the movement region M1 of the second group unit 101 and the movement region M2 of the third group unit 102 overlap (overlapping region: overlap OL).

Note that in the present embodiment, from among the movement region M1 and the movement region M2, the distance for the overlap OL is larger than the distance for the regions that are not the overlap OL.

The zones are set such that when the second group unit 101 is in the zone C, the third group unit 102 cannot be in the zone D (it must be in the zone E).

In addition, the reference position P2 is located outside of the range of the overlap OL (outside of the overlapping region) and the reference position P1 is located inside the range of the overlap OL (inside of the overlapping region).

It is thereby possible to shorten the time taken for the reset drive even if the second group unit 101 and the third group unit 102 have overlap OL in their respective movement region M1, and movement region M2.

In addition, the reference position P3 is set within the range of the overlap OL. It is thereby possible to shorten the time taken for the reset drive even if the second group unit 101 and the third group unit 102 have overlap OL in their respective movement region M1 and movement region M2.

However, it becomes a requirement that the distance for the movement region M1 or the movement region M2 is less than half of the distance for the overlap OL.

In addition, settings are also made such that the distance for the zone E is shorter than the distance for the zone D. It is thereby possible to decrease the movement speed of the third group unit 102 in the zone E, and to adjust (lengthen) the time taken for a reset drive (the reset time)

The second group unit 101 is driven by 1 to 2 phases in which the greatest speed of the first stepping motor 103 is 1600 pps (pulses per second), wherein 1 pulse is 10 μm. The third group unit 102 is driven by 1 to 2 phases in which the greatest speed of the second stepping motor 104 is 3000 pps, wherein one pulse is 10 μm.

The mass of the third group unit 102 is lighter than the mass of the second group unit 101, and therefore, the greatest speed of the third group unit 102 is set so as to be faster than the greatest speed of the second group unit 101.

As has been explained above, the reset drive is an operation in which the reference positions P1, P2, and P3 of the second group unit 101 and the third group unit 102 are detected before performing image capturing by moving the second group unit 101 and the third group unit 102.

Below, the specific operations that occur during the reset drive will be explained with respect to processing and the like

### (Case 1)

When the second group unit 101 exists in the zone A, movement begins toward the zone B (the image capturing side) at the greatest speed of 1600 pp. The second group unit 101 moves toward the switching point where the photo interrupter 132 switches from low to high (the reference position P2).

The third group unit 102 begins to move toward the zone E at the greatest speed of 3000 pps when it exists in the zone D, and when the third group unit 102 exists in the zone E, it begins to move toward the zone D at the greatest speed of 3000 pps. That is, the third group unit 102 moves toward the switching position for the photo interrupter 133 (the reference position P3)

That is, even if the second group unit 101 moves toward the image capturing side at the greatest speed of 1600 pps, the third group unit 102 will move toward the image capturing side at the greatest speed of 3000 pps. Although the second group unit 101 and the third group unit 102 move in the same direction, the second group unit 101 will not catch up with the third group unit 102, and therefore, collisions between the second group unit 101 and the third group unit 102 are avoided.

Conversely, even if the second group unit 101 moves to the reference position P2 on the image capturing side from the zone A, the third group unit 102 will only move until the reference position P3 of the object side from the zone E. Although the second group unit 101 and the third group unit 102 move in directions that approach each other, they will both stop in positions that are separated from each other, and therefore collisions between the second group unit 101 and the third group unit 102 are avoided. In particular, the reference position P2 is located outside of the range of the overlap OL, and therefore, there is no danger of the second group unit 101 and the third group unit 102 colliding, and it is possible to move both the second group unit 101 and the third unit 102 at their respective greatest speeds.

### (Case 2)

When the second group unit 101 is in the zone B, it begins to move at the greatest speed of 1600 pps toward the zone A (toward the object side). The second group unit 101 moves toward the position at which the photo interrupter 132 switches from high to low (the reference position P2).

When the third group unit 102 is in the zone D, it begins to move toward the zone E at the greatest speed of 3000 pps, and when the third group unit 102 is in the zone E, it begins to move toward the zone D at the greatest speed of 3000 pps. That is, the third group unit 102 moves toward the switching position for the photo interrupter 133 (the reference position P3).

That is, even if the second group unit 101 moves toward the object side from the zone B at the greatest speed of 1600 pps, the third group unit 102 will move toward the image capturing side from the zone D at the greatest speed of 3000 pps. The second group unit 101 and the third group unit 102 are moving in directions that move away from each other, and therefore, a collision between the second group unit 101 and the third group unit 102 is avoided.

Conversely, even if the second group unit 101 moves to the second reference position P2 from the zone B, the third group unit 102 will only move to the reference position P3 on the object side from the zone E. Although the second group unit 101 and the third group unit 102 move in the same direction, they will both stop in different positions, and therefore, a collision between the second group unit 101 and the third group unit 102 is avoided. In particular, the reference position P2 is located outside of the range of the overlap OL, and therefore, there is no danger of the second group unit 101 and the third group unit 102 colliding, and it is possible to move the second group unit 101 and the third group unit 102 at their respective greatest speeds.

### (Case 3)

When the second group unit 101 is in the zone C, it begins to move toward the zone B (the object side) at the greatest speed of 1600 pps. The second group unit 101 is moving toward the position at which the photo interrupter 131 switches from low to high (the reference position P1).

The third group unit 102 is necessarily in the zone E, and therefore it begins to move toward the switching position for the photo interrupter 133 (the reference position P3). At this time, movement is performed by dropping the speed to 1600 pps. In addition, after a predetermined time has elapsed, the movement speed of the third group unit 102 is increased to 2400 pps.

That is, even if the second group unit 101 moves toward the object side from the zone C at the greatest speed of 1600 pps, the third group unit 102 will move at the same speed (1600 pps) toward the object side from the zone E. Although the second group unit 101 and the third group unit 102 are moving in the same direction, the third group unit 102 will not catch up to the second group unit 101, and therefore, a collision between the second group unit 101 and the third group unit 102 is avoided. In addition, when a state has been reached in which a collision between the second group unit 101 and the third group unit is physically avoided (in which it is impossible for the third group unit 102 catch up with the second group unit 101), the movement speed for the third unit 102 will be increased.

The movement speed for the third group unit 102 will now be explained in detail. The distance for the reference position P1 and the reference position P3 is made X1 (mm) and the distance for the zone C is made X2 (mm). X2 (mm) is the distance from the movement end of the overlap OL side of the second group unit 101 to the first reference position P1.

The greatest speed for the second group unit 101 is made V1 (mm/s), and the greatest speed for the third group unit 102 is made V2 (mm/s). The time difference for when the second group unit 101 and the third group unit 102 start moving is made Δt(s).

The above-described pre-determined time is a time t(s) during which it has become impossible for the third group unit 102 to catch up with the second group unit 101. In other words, it is a time t(s) during which the movement speed of the third group unit 102 is updated.

The time t(s) can be found using the following Formula (1)

t=(X2−X1)/V1−Δt (1)

Specifically, X1=3.5 mm, X2=6.5 mm, V1=16 mm/s, V2=24 mm/s, and Δt=0 s.

Then the time t=0.1875 (s).

When the second group unit 101 is in the zone C and the third group unit 102 is in the zone E, the reset drive begins (is started up) and after approximately 0.19 seconds, the speed of the third group unit 102 will change from V1 to V2.

That is, the third group unit 102 is moved at a low speed (V1) until the second group unit 101 moves past the position that corresponds to the reference position P3 from the movement end (terminus) of the zone C. In addition, if the time t(s) that it takes for the second group unit 101 to move past the reference position P3 elapses, the speed of the third group unit 102 is changed to the speed (V2).

It thereby becomes possible to shorten the time taken for a reset drive while avoiding a collision between the second group unit 101 and the third group unit 102.

At the start time for the reset drive, although the precise positions of the second group unit 101 and the third group unit 102 are unclear, it is possible to detect the zones (regions) in which the second group unit 101 and the third group unit 102 exist. That is, at the start time for the reset drive, it is possible to recognize which case from among the case 1 to the case 3 is present.

In this context, the movement speed for the third group unit 102 is set (made to be different) based on the zones in which the second group unit 101 and the third group unit 102 exist and the movement directions of the second group unit 101 and the third group unit 102.

In this manner, at the time of the reset drive, the second group unit 101 and the third group unit 102 are moved at the same time. The movement speed (reset drive condition) is changed according to the zones in which the second group unit 101 and the third group unit 102 exist, and the movement directions of the second group unit 101 and the third group unit 102. At the time of the reset drive, when the second group unit 101 and the third group unit 102 are moving in directions that move away from each other, and when they are moving in directions that approach each other, the reset drive conditions are changed. In particular, in cases in which there is a possibility that the second group unit 101 and the third group unit 102 will collide at the time of the reset drive, the movement speed of the unit with a faster movement speed (the third group unit 102) is reduced.

It is thereby possible to avoid collisions between the second group unit 101 and the third group unit 102 at the time of the reset drive even if the second group unit 101 and the third group unit 102 are being moved at the same time.

Note that at the time of case 3, it can also be made such that Δt≠0s. At the time of the other cases, case 1, and case 2, this may also be switch to Δt=0 s. For example, settings may be made such that it is always Δt=0.1 s. That is, the start timing at the time of the reset drive of the third group unit 102 may be changed (made later) in any of the cases. That is, the start timings (the reset drive conditions) for the second group unit 101 and the third group unit 102 may be made different from each other.

However, it is preferable if Δt(s) is a shorter time than the time that it takes to complete the reset drive (movement) of the second group unit 101. While the second group unit 101 is moving, the third group unit 102 will begin moving. That is, it is preferable if the second group unit 101 and the third group unit 102 move at the same time.

It also thereby becomes possible to shorten the time that it takes to perform the reset drive.

As has been described above, according to the lens barrel 100 of the present embodiment, it is possible to quickly avoid collisions between moving lens frames (the second group unit 101, and the third group unit 102) at the time of the reset drive by using a simple configuration. In this manner, it is possible to avoid collisions between moving lens frames at the time of the reset drive at a low cost.

### Second Embodiment

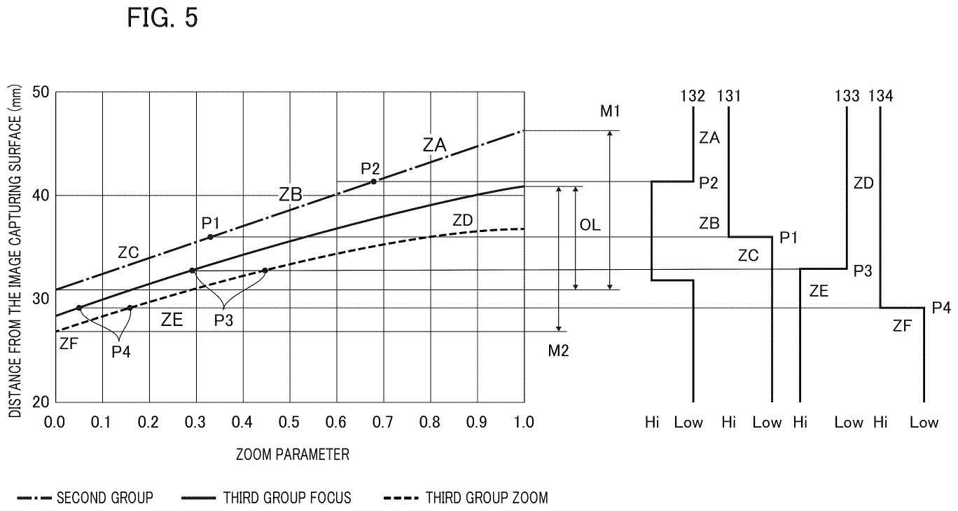

FIG. 5 is a diagram showing a relationship between loci of moving lens frames (the second group unit 101, and the third group unit 102) and outputs of the photo interrupters 130 (the photo interrupters 131, 132, 133, and 134) in the Second Embodiment.

A photo interrupter (a second detection unit) 134 is added, and a reference position (a fourth reference position) P4 of the third group unit 102 is set as a zone F (abbreviation: ZF). At this time, the reference position P4 is located outside of the range for the overlap OL.

Note that the specific operations, processing, and the like that occur during the reset drive are the same as the operations, processing, and the like for the cases 1, 2, and 3, in the above-described First Embodiment. The Second Embodiment differs from the First Embodiment on the point that there is a further case 4.

In the case 4, the following operations, processing, and the like are performed.

### (Case 4)

If the third group unit 102 exists in the zone E, the third group unit 102 will begin to move toward the switching position (the reference position P4) for the photo interrupter 134 at the maximum speed of 3000 pps.

The second group unit 101 exists in any of the zones A to C, and will begin to move toward the reference position P1 or the reference position P2 at the maximum speed of 1600 pps.

That is, the third group unit 102 moves toward the object side at the maximum speed of 3000 pps, and reaches the reference position P4. Collisions between the second group unit 101 and the third group unit 102 are thereby avoided even if the second group unit 101 is moving in any direction at the maximum speed of 1600 pps.

Therefore, it is possible to further shorten the time take to perform the reset drive according to the lens barrel 100 of the Second Embodiment.

### Third Embodiment

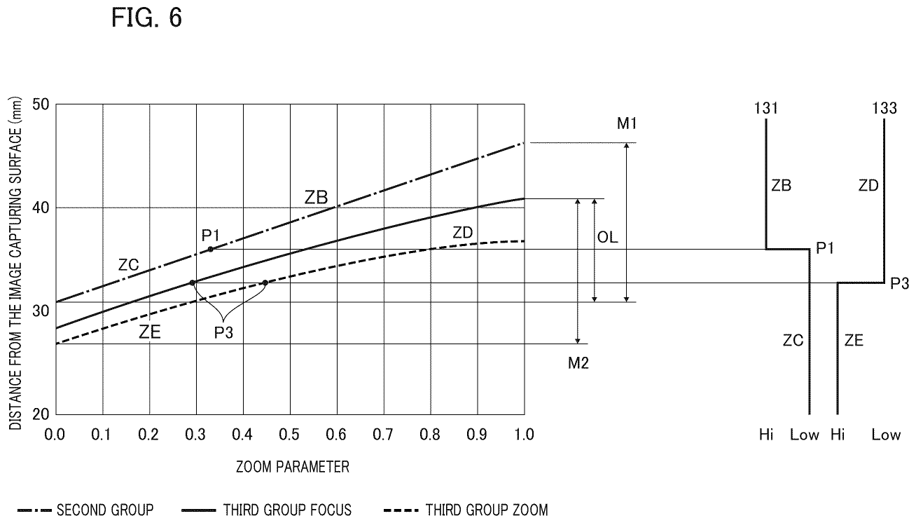

FIG. 6 is a diagram showing the relationship between loci of moving lens frames (the second group unit 101, and the third group unit 102) and the outputs of the photo interrupters 130 (the photo interrupters 131, and 133) in the Third Embodiment.

In the Third Embodiment, the photo interrupter 132 is separated from the configuration of the lens barrel 100, and the reference position P2 and the zone A of the second group unit 101 are removed.

Note that the specific operations, processing, and the like that occur during the reset drive are the same as the operations, processing, and the like for the cases 2, and 3 of the above-described First Embodiment.

However, the Third Embodiment differs from the First Embodiment with respect to a portion of the operations that occur during the case 2. In the case 2 of the Third Embodiment, the second group unit 101 begins to move toward the reference position P1 from the zone B at the maximum speed of 1600 pps.

At this time, even if the second group unit 101 moves from the zone B to the image capturing side at the maximum speed of 1600 pps, the third group unit 102 will move from the zone D to the image capturing side at the maximum speed of 3000 pps. The second group unit 101 will thereby not catch up with third group unit 102, and therefore, collisions between the second group unit 101 and the third group unit 102 are avoided. Conversely, even if the second group unit 101 moves from the zone B to the reference position P1, the third group unit 102 will only move from the zone E to the reference position P3 on the object side. Although the second group unit 101 and the third group unit 102 are moving in directions that approach each other, they will both stop in different positions, and therefore, collisions between the second group unit 101 and the third group unit 102 are avoided.

Therefore, it is possible to further shorten the time taken to perform the reset drive according to the lens barrel 100 of the Third Embodiment.

### Other Embodiment

The drive unit is not limited to a stepping motor (STM). For example, a drive mechanism such as an oscillation actuator (ultrasonic motor), a voice coil motor (VMC), or the like may also be used.

The detection unit is not limited to a photo interrupter. For example, the detection unit may also count pulses of the stepping motor and detect a movement amount and movement direction of the moving lens frames (the second group unit 101, and the third group unit 102).

The base cylinder 107 is not limited to cases in which it is fixed to the lens barrel 100. For example, the base cylinder 107 may also move in the optical axis direction O while holding both the second group unit 101 and the third group unit 102.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-191914, Nov. 10, 2023, which is hereby incorporated by reference wherein in its entirety.

What is claimed is:

1. A lens barrel comprising:
a first moving lens frame and a second moving lens frame, wherein there are overlapping regions in a movement range of the first moving lens frame and a movement range of the second moving lens frame;
a drive unit configured to move the first moving lens frame in an optical axis direction and to move the second moving lens frame in the optical axis direction;
a detection unit configured to detect a reference position of the first moving lens frame and a reference position of the second moving lens frame; and
a control unit configured to perform a reset drive in which the first moving lens frame is moved to the reference position of the first moving lens frame and the second moving lens frame is moved to the reference position of the second moving lens frame; wherein
the control unit changes reset drive conditions for the first moving lens frame or the second moving lens frame based on outputs from the detection unit.

2. The lens barrel according to claim 1, wherein the control unit moves the first moving lens frame and the second moving lens frame at the same time.

3. The lens barrel according to claim 1, wherein the reset drive conditions are a movement speed or a start timing.

4. The lens barrel according to claim 1, wherein the control unit is configured to change the reset drive conditions for the second moving lens frame, and wherein the movement speed of the second moving lens frame is higher than the movement speed of the first moving lens frame.

5. The lens barrel according to claim 1, wherein the control unit is configured to change the reset drive conditions for the second moving lens frame, wherein the movement range for the second moving lens frame is smaller than the movement range for the first moving lens frame.

6. The lens barrel according to claim 1, wherein the detection unit is configured to detect which of a plurality of regions the first moving lens frame and the second moving lens frame exist in, wherein the plurality of regions is segmented by positioning the reference positions on the borders of the plurality of regions; and
the control unit is configured to change the reset drive conditions based on regions in which the first moving lens frame and the second moving lens frame exist.

7. The lens barrel according to claim 1, wherein the detection unit comprises:
a first detection unit configured to detect a first reference position and a second reference position of the first moving lens frame; and
a second detection unit configured to detect a third reference position of the second moving lens frame; wherein
the first reference position and the third reference position exist in the overlapping regions.

8. The lens barrel according to claim 1, wherein, the detection unit comprises:
a first detection unit configured to detect a first reference position and a second reference position of the first moving lens frame; and
a second detection unit configured to detect a third reference position and a fourth reference position of the second moving lens frame; wherein
the first reference position and the third reference position exist in the overlapping regions.

9. The lens barrel according to claim 1, wherein the detection unit comprises:
a first detection unit configured to detect a first reference position of the first moving lens frame; and
a second detection unit configured to detect a third reference position of the second moving lens frame; wherein
the first reference position and the third reference position exist in the overlapping regions.

10. The lens barrel according to claim 1, wherein the control unit is configured to change a movement speed of the second moving lens frame when a time t found using a formula given below has elapsed since a start time for the first moving lens group,
t=(X2−X1)/V1−Δt
Provided that,
X: a distance between a first position of the first moving lens frame and a third position of the second moving lens frame
X2: a distance from a moving end of the first moving lens frame to the first reference position
V1: a movement speed of the first moving lens frame
Δt: a difference between a start time of the first moving lens frame and a start time of the second moving lens frame.

11. The lens barrel according to claim 1, wherein the movement range is configured such that the overlapping regions have a larger distance than regions that are not the overlapping regions.

12. The lens barrel according to claim 1, wherein the drive unit is a stepping motor.

13. The lens barrel according to the claim 1, wherein the detection unit is configured to be able to detect a movement amount and a movement direction of the first moving lens frame and a movement amount and a movement direction of the second moving lens frame.

14. The lens barrel according to claim 1, wherein the lens barrel is configured to further comprise a base cylinder configured to hold both the first moving lens frame and the second moving lens frame, and to move in the optical axis direction.

15. The lens barrel according to claim 1, wherein at least one of the first moving lens frame and the second moving lens frame is a zooming lens frame.

16. The lens barrel according to claim 1, wherein at least one of the first moving lens frame and the second moving lens frame is a focusing lens frame.

17. An optical apparatus comprising:
a lens barrel comprising: a first moving lens frame and a second moving lens frame, wherein there are overlapping regions in a movement range of the first moving lens frame and a movement range of the second moving lens frame; a drive unit configured to move the first moving lens frame in an optical axis direction and to move the second moving lens frame in the optical axis direction; a detection unit configured to detect a reference position of the first moving lens frame and a reference position of the second moving lens frame; and a control unit configured to perform a reset drive in which the first moving lens frame is moved to the reference position of the first moving lens frame and the second moving lens frame is moved to the reference position of the second moving lens frame; wherein the control unit changes reset drive conditions for the first moving lens frame or the second moving lens frame based on outputs from the detection unit; and
a camera body to which the lens barrel has been fixed or removably mounted.
